(19) United States
(12) Patent Application Publication
(10) Pub. No.: US 2020/0178549 A1
(43) Pub. Date: Jun. 11, 2020

(54) GARLIC MARINATING PROCESS

(71) Applicant: Maurizio GIACCHETTI, Camerano (AN) (IT)

(72) Inventor: Maurizio GIACCHETTI, Camerano (AN) (IT)

(21) Appl. No.: 16/631,789

(22) PCT Filed: Jul. 19, 2017
(86) PCT No.: PCT/IT2017/000149

§ 371 Date: Jan. 16, 2020

(51) Int. Cl. A23B 7/005; A23L 19/00; A23L 19/20; A23L 5/20; A23L 27/14; A23L 27/12; A23L 33/15; A23L 27/10

(52) U.S. Cl. CPC A23B 7/0053; A23L 19/03; A23L 19/20; A23L 5/21; A23V 2002/00; A23L 27/13; A23L 33/15; A23L 27/105; A23L 27/14

(57) ABSTRACT

A marinating process of garlic cloves, including: immersing the peeled garlic cloves in a receptacle with drinking water; during the step of immersing the garlic cloves in the drinking water, changing the drinking water, mixing the drinking water contained in the receptacle, blowing air in the receptacle and heating the drinking water to a temperature comprised between 45° and 50° C.; then letting the drinking water flow out of the receptacle, introducing a solution of drinking water, vinegar and anti-oxidants in the receptacle, letting the garlic cloves marinate in the solution and draining the garlic cloves in order to eliminate the solution.

The present patent application for industrial invention relates to a garlic marinating process. The reference sector is gastronomy, in particular in-oil preserved foods.

It is known that garlic is rich in mineral and oligomineral substances that are healthy for the human body, such as magnesium, calcium, phosphorus, iodine, iron, zinc, manganese, selenium, vitamin C, vitamins B1-B2-PP and provitamin A.

Moreover, garlic has beneficial properties for the body. More precisely, garlic reinforces the immune system and acts as powerful bactericide and vermicide for the body. Moreover, the intake of garlic regulates the blood pressure, reduces the risk of sclerosis for the arteries, prevents the formation of thrombi, and stabilizes the level of cholesterol and triglycerides in the blood.

Furthermore, garlic can be used as antibiotic when the intestinal bacterial flora is altered by previous treatments. Unlike chemical antibiotics, garlic eliminates pathogen bacteria, while favoring the restoration of bacterial flora.

As it is known, the intake of garlic favors the protection against heavy metals that are harmful for the body. Heavy metals enter the body through smog, dental fillings, and contaminated fruits and vegetables. In such a case, garlic acts as chelator, that is to say it binds with molecules of heavy metals in the body and eliminates them.

Moreover, it must be noted that garlic gives a healthy aspect to the skin and favors hair growth.

Furthermore, garlic comprises alkaloid substances that carry out a similar action to insulin, reducing the glycemia level in the blood.

It is therefore recommended to take garlic regularly in order to benefit from its therapeutic properties.

In spite of having many beneficial properties for the body, garlic has several drawbacks.

A first inconvenience consists in the fact that garlic has an unpleasant flavor and smell.

The unpleasant flavor and smell of garlic are due to the presence of sulphured compounds, in particular allicin. Garlic releases its typical smell when it is chewed, cut or pressed.

Because of said unpleasant smell and flavor, garlic is used for food flavoring, but is not ingested.

A second drawback of garlic consists in the fact that it is not very digestible after being cooked.

Such drawbacks discourage the ingestion of garlic, thus preventing the body from benefiting from the therapeutic properties of garlic.

CN101066115 discloses a preparation process of jars with flavored garlic cloves that provides for the following steps:
heating the garlic cloves in water at high temperature (90-100°),
three brining steps of the garlic cloves in such a way to increase the salinity of the garlic cloves to 20-30%,
two desalting steps of the garlic cloves in such a way to reduce the salinity of the garlic cloves to 3-15%,
marinating the garlic cloves in a vinegar solution.

Such a process is impaired by drawbacks related to the heating step of the garlic cloves in high temperature water. In fact, the heating of the garlic cloves at a temperature of 90-100° C. impairs the organoleptic characteristics of the garlic cloves. Moreover, since it contains a high quantity of salt, the brine tends to dehydrate the garlic cloves, further reducing their organoleptic properties.

The purpose of the present invention is to remedy the drawbacks of the prior art by disclosing a garlic marinating process that improves the digestibility of garlic and eliminates its unpleasant smell and taste.

An additional purpose is to disclose a garlic marinating process that does not alter the chemical-physical structure of the garlic.

The garlic marinating process of the invention provides for using peeled garlic cloves with a salt concentration comprised between 10% and 25% and a citric acid content of 0.5%. Such a process has a total duration comprised between 3 and 5 days. Initially, such a process provides for a step of immersing the garlic cloves in a receptacle, known as desalter, containing drinking water, for an immersion time comprised between 2 and 4 days, in order to reduce the salt concentration of the garlic to 2%. The quantity of garlic cloves introduced in the receptacle is equal to the quantity of water contained in the receptacle. In fact, it must be noted that the introduction of a quantity of garlic cloves lower than the quantity of water contained in the receptacle would excessively rinse the garlic cloves, consequently reducing the organoleptic properties of the garlic cloves. On the contrary, the introduction of a quantity of garlic cloves higher than the quantity of water contained in the receptacle would extend the desalting time of the garlic cloves.

It must be noted that the term “desalter” indicates a receptacle comprising:
air blowers to blow air in the receptacle;
a ball valve to introduce drinking water in the receptacle;
a lower opening advantageously connected to a hose to let the drinking water out of the receptacle;
recirculation pumps to re-circulate the water contained in the receptacle;
thermal regulators to heat the water contained in the receptacle.

During the step of immersing the garlic cloves in the drinking water contained in the desalter:
the drinking water contained in the desalter is changed by introducing new drinking water in the desalter by means of the ball valve and by draining the salt drinking water contained in the desalter through the lower opening of the desalter;
the drinking water contained in the desalter is mixed by the recirculation pumps of the desalter, in such a way that all garlic cloves have the same salt concentration;
air is blown in the desalter by the air blower of the desalter, in such a way to create bubbling intended to make the garlic fumes evaporate;
the drinking water contained in the desalter is heated to a temperature comprised between 45° and 50° in order to maintain a chemical-physical structure of the garlic cloves, and then is cooled to ambient temperature.

More precisely, during the first 30-60 hours from the step of immersing the garlic cloves in the drinking water contained in the desalter, the ball valve is left open in such a way to have a continuous water exchange. In particular, approximately 50 l/h of drinking water come out of the ball valve and are introduced in the desalter. Simultaneously, the same quantity of water comes out of the lower opening of the desalter and is drained by means of the pipe connected to said lower opening. The opening of the desalter is disposed in lower position in such a way that the water coming out of said opening of the desalter is the water that is disposed on the bottom of the desalter, that is to say water with a higher salinity. In fact, having a higher weight than the fresh water, the salty water tends to go down. In this way, the water contained in the desalter can be continuously exchanged, eliminating the saltiest water and introducing new fresh clean water, thus desalting the garlic cloves inside the desalter.

Simultaneously with such an exchange of the drinking water contained in the desalter, the air blowers of the desalter are operated in intermittent mode for time intervals of approximately 4-8 hours.

After approximately 20-30 hours from the beginning of the step of immersing the garlic cloves in the drinking water contained in the desalter, the water recirculation pumps are started and operated for the following 4-10 hours, in such a way that the water contained in the desalter is mixed and all garlic cloves have the same salt concentration and the same flavor.

After 30-60 hours from the beginning of the step of immersing the garlic cloves in the drinking water contained in the desalter, the garlic cloves immersed in the water are heated to a temperature of 45-50° C. by means of the temperature regulators of the desalter. Advantageously, the air blowers of the desalter are operated at the minimum speed in order to blow a minimum air quantity in the desalter.

In this way, the chemical-physical structure of the garlic cloves is maintained. In fact, experimental studies and tests have shown that the alliinase enzyme is deactivated by heating the garlic cloves at a temperature of 45-50° C., avoiding the conversion of the alliin molecule into allicin, and consequently improving the flavor and digestibility of garlic.

Successively, the air blowers and the temperature regulators of the desalter are switched off, in such a way to let the drinking water contained in the desalter rest for approximately 1 hour.

The step of immersing the garlic cloves in the water contained in the desalter ends with the activation of the air blowers of the desalter, in such a way that the garlic cloves immersed in the water contained in the desalter are cooled to ambient temperature. Such a cooling lasts for 4-8 hours.

At the end of the step of immersing the garlic cloves in the water contained in the desalter, the salinity of the garlic cloves is checked because it must not exceed 2%.

If the check has a negative outcome, the drinking water contained in the desalter is changed again, in such a way to desalt the garlic cloves further.

Instead, if the check has a positive outcome, the drinking water flows out of the desalter, and a solution of drinking water, vinegar and anti-oxidants is poured in the desalter. In particular, such a solution is advantageously composed of the following weight percentages:
34-38% of vinegar,
2-6% of salt,
0.1-0.3% of citric acid,
0.02-0.08% of ascorbic acid,
57-61% of water.

Such a solution is indiscriminately poured on the garlic cloves contained in the desalter, in such a way to cover all garlic cloves. The garlic cloves are marinated in the solution for 10-14 hours, in such a way to reduce the pH of the garlic cloves to 3.2 and prevent the garlic cloves from getting oxidized, thus maintaining a white color.

Finally, the garlic cloves are drained in order to eliminate the solution, at least partially.

Such a processing method of the garlic cloves reduces the unpleasant flavor of garlic to an imperceptible level, giving the garlic cloves a pleasant flavor without impairing their organoleptic characteristics and the beneficial properties for the human body, such as a reduction of the cholesterol level, a sense of lightness and a reduction of the blood pressure.

As a result, the garlic cloves are ready to be seasoned.

The garlic cloves are drained and dumped on stainless steel tables in order to be seasoned before being packaged in different containers.

Now the garlic cloves to be seasoned are sorted in such a way to eliminate any dark, broken or deformed cloves. After completing the sorting operation of the garlic cloves, the sorted garlic cloves are seasoned by adding the following spices:
black pepper powder;
crushed dried tomato;
parsley;
linen seeds.

The seasoning is indiscriminately distributed on the surface of the garlic cloves and, successively, the garlic cloves are mixed by hand.

It must be noted that, after marinating and seasoning the garlic cloves, said garlic cloves have a salinity of 2.5-3%.

The garlic cloves and the additional ingredients are ready to be packaged in jars.

Therefore, the seasoned garlic cloves are poured in the jars and sunflower oil is poured in a receptacle. Successively, curcuma is introduced in the receptacle that contains sunflower oil in such a way to mix the sunflower oil and the curcuma to obtain a sunflower oil-curcuma mix. In particular, 3.5 g of curcuma are diluted for every kg of sunflower oil.

The sunflower oil-curcuma mix is poured in the jars with the seasoned garlic cloves in such a way that the garlic cloves are immersed in the sunflower oil-curcuma mix.

The alliin contained in the garlic cloves and the curcuminoids contained in the curcuma favor the anti-oxidant, hypoglycaemic, antitumoral, antithrombotic, antibacterial, antiviral, hepatoproteinic and anti-fungus activity.

The combination of the black pepper powder and the curcuma makes it possible for a consumer to absorb the curcuma completely and benefit from all its properties that are beneficial for the body.

The ratio between the black pepper powder and the curcuma must be equal to 100 grams of curcumin and 1 gram of piperin to increase the efficacy of the curcuma absorption. In fact, experimental clinical tests have shown that piperin increases the bioavailability of curcumin when taken orally. This is because piperin is a powerful inhibitor of the metabolism of nutrients, and inhibits the hepatic and intestinal glucuronidation that slows down the metabolism of curcuma as a consequence. It is for this reason that the oral administration of curcuma and piperin determines high serum concentrations of the active compound after 1-2 hours from administration.

The jars are hermetically closed with caps and pasteurized at a temperature comprised between 88° and 90° in order to achieve a temperature comprised between 72° and 76° C. in the center of the jar for 8 to 15 minutes, in such a way to guarantee that the thermal shock is short and does not alter the organoleptic characteristics of the garlic cloves, while eliminating the germs and bacteria contained in the jar.

At the end of the packaging and pasteurization process, the garlic cloves have a yellow external layer with a thickness of approximately 1 mm; the yellow external color is due to the presence of the curcuma.

The advantages of the garlic marinating process of the invention are evident because of the fact that the garlic has a good flavor and a pleasant smell thanks to the immersion in the compound and in the heated water.

Moreover, the garlic is very digestible and versatile because it can be used both as appetizer and in pasta dishes or salads.

1. Marinating process for garlic cloves, said marinating process comprising the following steps:
immersing peeled garlic cloves with a salt concentration from 10% to 25% in a receptacle with drinking water, for an immersion time comprised between 2 and 4 days, in order to reduce a salt concentration of the garlic to 2%;
during the step of immersing the garlic cloves in the drinking water contained in the receptacle, changing the drinking water contained in the receptacle;
during the step of immersing the garlic cloves in the drinking water contained in the receptacle, mixing the drinking water contained in the receptacle in such a way that all garlic cloves have the same salt concentration;
during the step of immersing the garlic cloves in the drinking water contained in the receptacle, blowing air in the receptacle in such a way to create bubbling intended to cause the evaporation of the garlic fumes;
during the step of immersing the garlic cloves in the drinking water contained in the receptacle, heating the drinking water contained in the receptacle to a temperature comprised between 45° and 50° C. in order to preserve a chemical-physical structure of the garlic cloves and letting the garlic cloves cool to ambient temperature;
letting the drinking water flow out of the receptacle;
introducing a solution of drinking water, vinegar and anti-oxidants in the receptacle, in such a way to cover the garlic cloves, and letting the garlic cloves marinate in the solution for 10-14 hours, in such a way to reduce the pH of the garlic cloves to 3.2 and prevent the oxidation of the garlic cloves;
draining the garlic cloves in order to eliminate the solution, at least partially.

2. The process of claim 1, wherein the step of immersing the garlic cloves in the drinking water contained in the receptacle provides for immersing a quantity of garlic cloves equal to the quantity of water contained in the receptacle.

3. The process of claim 1, wherein, the following steps are provided after the step of draining the garlic cloves in order to eliminate the solution, at least partially:
placing the garlic cloves in ajar;
pouring sunflower oil in a receptacle;
introducing curcuma in the receptacle with the sunflower oil;
mixing the sunflower oil and the curcuma in the receptacle, in such a way to obtain a sunflower oil-curcuma solution;
pouring the sunflower oil-curcuma solution in the jar with the garlic cloves, in such a way that the garlic cloves are immersed in the sunflower oil-curcuma solution.

4. The process of claim 1, wherein the step of immersing the garlic cloves in the drinking water contained in the receptacle, for the first 30-60 hours, provides for:
leaving a ball valve of the receptacle open, in such a way that drinking water is introduced inside the receptacle and, simultaneously, salt water comes out of the receptacle from a lower opening of the receptacle;
operating air blowers of the receptacle in an intermittent mode for time intervals of approximately 4-8 hours;
after approximately 20-30 hours from the beginning of the step of immersing the garlic cloves in the drinking water contained in the receptacle, operating recirculation pumps of the water contained in the receptacle for the following 4-10 hours.

5. The process of claim 1, wherein during the heating of the drinking water contained in the receptacle to a temperature comprised between 45° and 50° C., air blowers of the receptacle are operated in such a way to blow air in the receptacle.

6. The process of claim 1, wherein the following steps are provided after the step of heating the water contained in the receptacle:
checking the salinity of the garlic cloves;
if the salinity of the garlic cloves is higher than 2%, the step of changing the drinking water contained in the receptacle is repeated, in such a way to desalt the garlic cloves further;
if the salinity of the garlic cloves is lower than 2%, the step of letting the drinking water out of the receptacle is carried out.

7. The process of claim 1, wherein the step of introducing a solution of drinking water, vinegar and anti-oxidants in the receptacle provides for pouring a solution with the following weight percentages in the receptacle:
34-38% of vinegar,
2-6% of salt,
0.1-0.3% of citric acid,
0.02-0.08% of ascorbic acid,
57-61% of water.

8. The process of claim 1, wherein, after the step of introducing a solution of drinking water, vinegar and anti-oxidants in the receptacle provides for seasoning the garlic cloves with the following spices:
black pepper powder;
crushed dried tomato;
parsley;
linen seeds.

9. The process of claim 8, wherein the seasoning step of the garlic cloves provides for:
dumping the garlic cloves onto a stainless steel table;
indiscriminately pouring the spices on the surface of the garlic cloves to be seasoned;
mixing the seasoned garlic cloves by hand.

10. The process of claim 8, wherein a step of sorting the garlic cloves is provided before the step of seasoning the garlic cloves, in such a way to sort the garlic cloves to be seasoned.
